(19) United States
(12) Patent Application Publication
(10) Pub. No.: US 2016/0353183 A1
(43) Pub. Date: Dec. 1, 2016

(54) COMMUNICATIONS INTERFACE

(71) Applicant: BRITISH TELECOMMUNICATIONS PUBLIC LIMITED COMPANY, London (GB)

(72) Inventor: John Andrew WARREN, London (GB)

(73) Assignee: British Telecommunications Public Limited Company, London (GB)

(21) Appl. No.: 15/117,319

(22) PCT Filed: Jan. 22, 2015
(86) PCT No.: PCT/GB2015/050141

§ 371 Date: Aug. 8, 2016

(30) Foreign Application Priority Data
Feb. 7, 2014 (EP) 14250023.0

(51) Int. Cl. H04Q 3/00; H04L 12/24; H04L 12/28

(52) U.S. Cl. CPC H04Q 3/0016; H04L 12/2878; H04L 41/0806

(57) ABSTRACT

A connection unit comprises a plurality of termination points for interconnection of telecommunications lines, for two or more different communications modes, for example fiber optic, coaxial, twisted pair, Ethernet etc. A connection block is arranged such that direct connection may be made between pairs of lines of a given mode. Connection between lines of different modes may be made through an external unit, which may for example be a DSLAM, or a Fiber/copper interface, connected through an umbilical connection, either wired in or connected by a plug and socket connection. This arrangement allows equipment to be connected to the connection block without access to the internal components of the connection unit, and allows interface units to be developed for new services without having to be accommodated within, or co-located with, the connection unit itself.

### CROSS-REFERENCE TO RELATED APPLICATIONS

The present application is a National Phase entry of PCT Application No. PCT/GB2015/050141, filed on 22 Jan. 2015, which claims priority to EP Patent Application No. 14250023.0, filed on 7 Feb. 2014, which are hereby fully incorporated herein by reference.

### TECHNICAL FIELD

This disclosure relates to interfaces in distribution networks for communications systems. In particular it is concerned with making provision for installation of interfaces between different communications modes.

### BACKGROUND

In conventional networks an exchange is connected to customer premises through a number of connection points. Traditionally these have been simple electrical connections. The wires connecting them are traditionally known as the “copper” network although it is not unknown for other conductive materials to be used in special conditions.

Although the telecommunications industry has developed more sophisticated, reliable and faster modes of communication than the basic analogue signal carried over a copper pair. For example, digital modes such as DSL (digital subscriber loop) which carries digitized data over the copper system, and other modes such as coaxial cable, and Ethernet also exist. In many cases it is not practical or economic to replace the entire network, and in particular the “final drop” between the distribution network and the subscriber's premises at one time, and inevitably the network has become a mixture of modes, with interfaces between them at various points in the network at which signaling is converted from one mode to another. A particular example is the fiber optic network, in which depending on the level of investment deemed appropriate, and the needs of the customers, the fiber/copper interface may be at the local exchange, or at the customer premises (fiber to the premises—FttP, also known as FttH, (fiber to the home) or FttB (fiber to the building), or at any of a number of intermediate points, such as the final distribution point (FttDP), or an intermediate location such as a principal connection point or curbside cabinet (FttC or FttK). Further complications arise when multiple modes are carried over the same physical medium, for example derived voice channels carried over a broadband communication line which have to be extracted from the digital carrier and converted to analogue for the final connection to an analogue telephone, as described in United States patent specification US2012/0294303.

In this specification, the term “communications mode” is used to mean a communications system distinguished from other modes by carrier medium, protocol, multiplexing system, or some other characteristics, such that an interface system other than a simple physical electrical or optical connection is required to convert between them. This may be an electrical/optical interface, a demultiplexer for extracting a channel from a multiplex (e.g. a “derived voice” channel), or any other protocol conversion.

As customer requirements change, so too may the appropriate interface point. Consequently, it is becoming increasingly common for different links in an end-to-end communications connection to operate in different modes, and in particular for the interfaces between those modes to be relocated as different customers upgrade at different times.

There is a general trend for the infrastructure to evolve by moving interfaces out from the exchange towards the customer premises, in particular the interface between fiber optic connections and wired “copper” connections. For example, conversion from fiber to the cabinet (FTTC) to “fiber to the distribution point” (FttDP) requires digital subscriber line access multiplexers (DSLAMs), previously installed at principal connection points (PCP) to instead be installed at distribution points, or at a remote node intermediate the principal connection point (PCP) and the Distribution Point. In such a case there would no longer be a DSLAM at the PCP and the redundant copper connections could be used for other purposes, for example delivering electrical power to DSLAMs at distribution points or remote nodes further from the exchange, using an existing local or exchange-fed power feed to the PCP.

At present any such reconfiguration requires the existing interface to be replaced to allow the new connections to be made. In particular, if a copper/copper connection is to be replaced by a copper/fiber interface a new installation is required, which may require re-wiring all the existing connections, including those which are not directly affected by the change. This is time consuming, and the number of connections involved increases the probability that errors may occur. Furthermore, all the connections have to be disturbed again if further connections are to be modified or upgraded: for example if a second DP served by the same PCP is to be converted to FTTDP.

Typically such interfaces are often located in positions where they may be exposed to damage from external influences, for example mounted on posts or buried under the ground. This requires the interface to be installed in a suitable enclosure to protect the connections from external influences such as frost, water ingress, earth movement, and vandalism. To avoid too much reconnection work in what can be difficult working conditions it is desirable that any reconfiguration can be done without replacing the enclosure with a different design. This can be difficult to design for if installation of new equipment (e.g. a DSLAM), whose design is unknown at the time of installing the enclosure, is envisaged at some time during the working life of the enclosure itself

### SUMMARY

According to the present disclosure there is provided a connection unit for interconnecting telecommunications lines, the connection unit comprising a plurality of termination points for interconnection of telecommunications lines for two or more different communications modes, and having a connection block arranged such that direct physical connection may be made between pairs of lines of a given mode, and having provision for physical connection between the connection unit and a first line operating according to a first mode, and physical connection between the connection unit and a second line operating according to a second mode, and physical connection between the connection unit and a co-operating interface unit, such that the interface unit may be arranged to convert signals between the first mode and the second mode.

The different modes may include any or all of fiber optic communications, twisted wire pairs, coaxial cable, multicore cables and local area network systems such as “Ethernet”. The connection unit may have provision for switching connections in the connection block in response to an external signal. Alternatively, manual reconnection may be used.

The connection unit may have a power connection for an electrical power supply to be delivered to the connection unit. This power supply may be used to operate the switching, power an optical/fiber conversion unit, or be delivered by a further power connection to another connection.

The connection unit may comprise a power management unit for extracting electrical power from a communications line and delivering the power to a destination different from a cross-connection of the communications carried on the communications line.

In one advantageous embodiment the termination points are housed in an enclosure, to protect them from accidental or malicious damage, weather, and other hazards. Provision may be made to incorporate interface units within the enclosure, but advantageously the interface units are housed separately. The enclosure may be provided with apertures for passage of communications lines to one or more of these external interface units. Alternatively, plug-and-socket connections may be made between the connection unit and one or more umbilical connections to respective interface units.

Embodiments therefore replace existing bespoke connectorized interfaces with a ‘hybrid’ connection unit having interconnected connection points of at least two types, (in the embodiment these are simple copper wire terminations and an optical fiber splice tray, but different or further types may be used). The unit can be configured to operate as a PCP structure, fiber DP, power node, a simple copper network connection, or any combination thereof depending on what exchange-side and user-side connections, and what interface equipment, is connected to the connection points.

In this embodiment provision is made for such interface equipment to be connected to the connection unit using an umbilical “tail”. This allows equipment designers more flexibility since the interface equipment may be installed in a separate enclosure at a convenient location, rather than being necessarily co-located in the same enclosure as the exchange-side and user-side connections. This also allows the equipment manufacturer or operator to access the interface equipment without access to connections which are not its responsibility. This is a significant advantage in installations where multiple service providers are involved, as the separate enclosures make it possible to arrange that each operator only has access to the equipment for which it is responsible.

The interface equipment and its umbilical will typically have connections to a connection on both the user side and the exchange side—possibly more than one of each—to form an intermediate connection point in the fixed network, but the connection unit may also be used to connect a termination of the fixed network: for example a wireless base station.

The interconnections in the connection unit can be arranged to be reconfigured either manually, by opening the enclosure and physically moving wires from one connection terminal to another, or remotely by switches activated remotely from the exchange or through one of the umbilical connections.

Power may be supplied for operation of the connection unit itself, or any interface equipment connected by a suitable umbilical, or for delivery over the wired connections to other equipment elsewhere in the network (exchange-side or customer-side). Such power may be supplied from a dedicated local mains feed, or from a battery in the housing or connected to it, or from one of more of the wired network connections (exchange-side or customer-side).

This closure can therefore be technology-independent and allow edge connectivity that will support evolving services. This allows a power, copper and fiber network to be installed to an aggregation point comprising such a connection unit, and that edge equipment can be developed independently by manufacturers and service providers to meet their own requirements, and evolve without the need to keep revisiting connectivity.

### BRIEF DESCRIPTION OF THE DRAWINGS

An embodiment will now be described by way of example with reference to the drawings, in which:

FIG. 1 is a depiction of a typical distribution network within which one or more connection units according to an embodiment may be installed.

FIG. 2 is a simplified topological drawing depicting the functional connections of a connection unit according to an embodiment, shown when connected to a first interface unit comprising a Fiber to the Distribution point (FttDP) interface.

FIG. 3 is similar to FIG. 2, but depicting the connection unit connected to a second interface unit comprising a Digital Subscriber Loop Access Multiplexer.

FIG. 4 depicts the FttDP interface unit of FIG. 2 in more detail.

FIG. 5 depicts the DSLAM interface unit of FIG. 3 in more detail.

FIG. 6 depicts a wireless transceiver unit which may be used with the connection unit of FIGS. 2 and 3.

### DETAILED DESCRIPTION

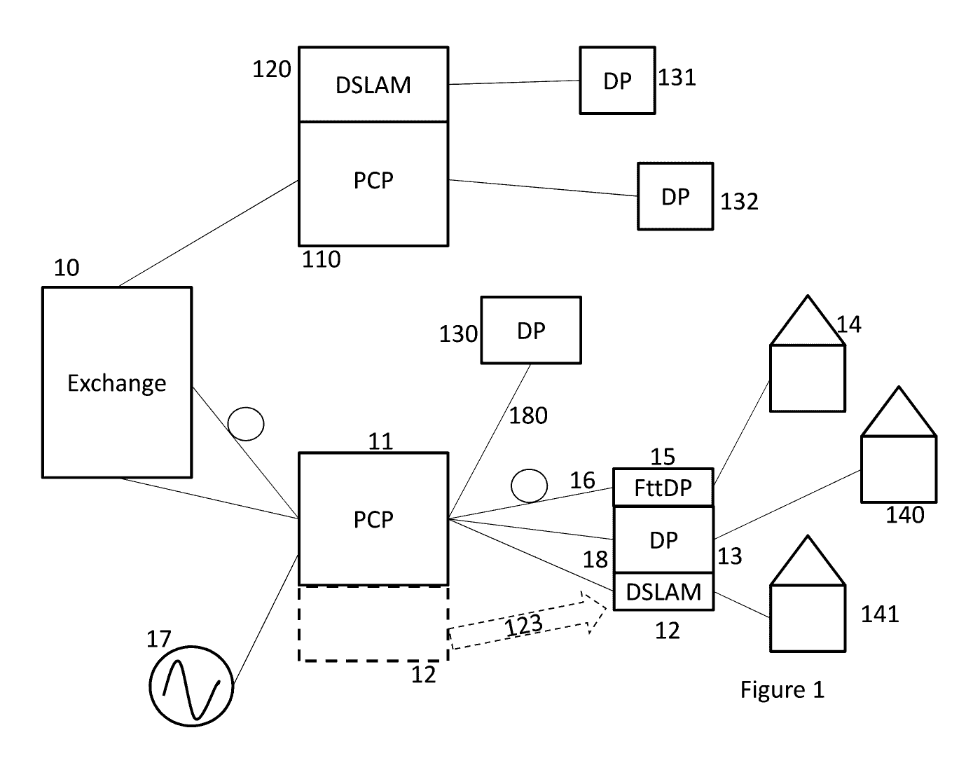

FIG. 1 depicts a typical network infrastructure having an exchange 10, a number of primary connection points (PCPs) 11, 110, each co-located with a cabinet which comprises a DSLAM 12, 120, and a plurality of distribution points (DPs) 13, 130, 131, 132 to each of which is connected a bigger plurality of customer premises 14, 140, 141 (only shown for one DP). A power supply 17 delivers power to the PCP 11 and, over the copper connections 18, 180, to its associated distribution points 13, 130 and customer premises 14, 140, 141.

As is indicated by the arrow 123, there is a trend for interfaces such as DSLAMs and fiber/optical interfaces to be moved further out into the network, away from the exchange and towards the customer premises. As is seen, there is a DSLAM 12 and a fiber/optic interface 15 associated with the distribution point 13, (rather than at the associated PCP 11), with a fiber optic connection 16 between the PCP 11 and the DP13.

Reconfiguring a distribution point e.g. 13 to accommodate such changes can be difficult to achieve, as such points are often located in places difficult to access. As the changes may be made at different times, for example connection of premises to the DSLAM or FttDP units may not all be done at the same time, or the DSLAM and FttDP may themselves require installation or replacement at different times. Such rearrangement may cause accidental disruption to existing connections. Embodiments are intended to make such reconfiguration simpler, by providing a common connection point to which connections and interface units may be added subsequently.

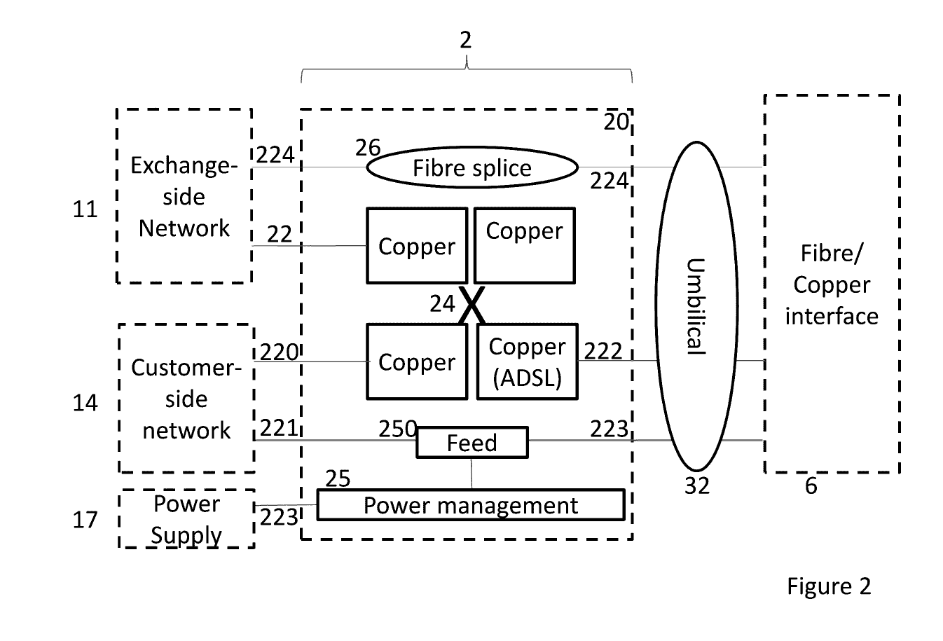

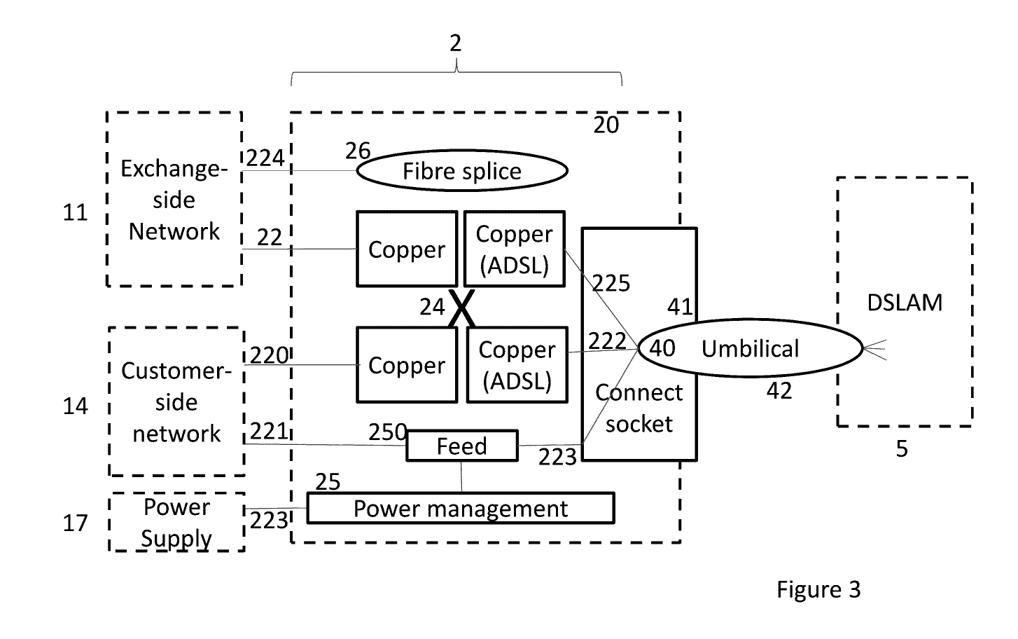

FIGS. 2 and 3 are schematics showing the functional relationships between the elements of a connection unit according to an embodiment. The connection unit is intended for installation at a distribution point 13.

The connection unit 2 comprises a housing 20 with a removable cover (not shown) to allow access to the components within. The housing is intended to protect the components within from accidental or malicious damage. Different types of casing may be provided depending on whether the connection is to be installed indoors, or in the open air (for example on a distribution pole) where it may be vulnerable to the weather or unauthorized interference, or under the ground where damage from flooding, ground movement or excavation may be possible.

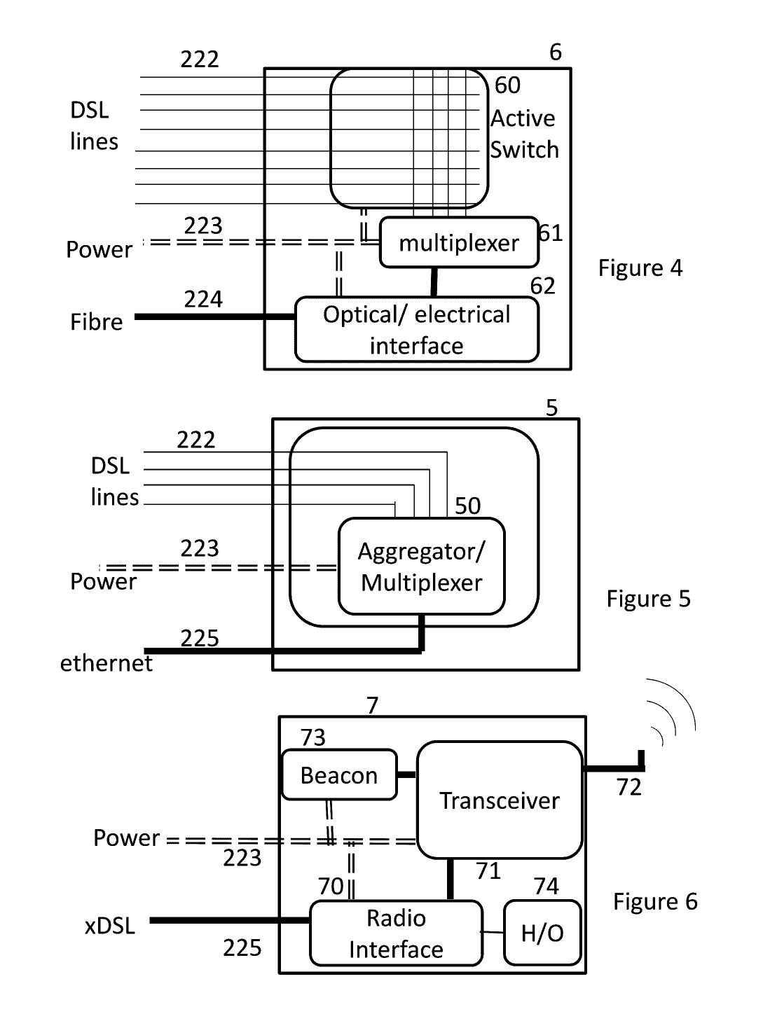

The connection unit has a number of external connections 22, 220, 221, 222, 223, 224 for connection to other elements of the network. These may include both fiber and electrical connections, the latter of which may be for communications or power or both. The connections will generally include connections to user premises and to the exchange (network) side (direct or through intermediate connection points) and provision is also made for umbilical connections 42, 52 to specialist equipment 5, 6,7 which will be discussed later, with reference to FIGS. 4, 5, and 6.

As shown in FIG. 2, electrical connections 22, 220, 221, 222 may each be wired in to appropriate terminals in an insulation displacement connection (IDC) block 24, such that connections can be made between them using jumper cables (not shown). A power terminal 25 is provided for connection, if required, to a power supply cable, 223. Alternatively, power may be drawn from one of the communications connections e.g. 221. Power may also be delivered to one or more of the connections e.g. 223. Distribution of power is under the control of a power feed control system 250. As shown in FIG. 2, optical fibers 224 can be connected in a splice tray 26.

Alternatively, as shown in FIG. 3, connection may be made by a plug 40 on the external connection connected to a socket 41 in the housing, the socket being already electrically connected to the IDC blocks 24. This arrangement allows equipment to be connected to the connection block without removing the cover from the housing.

Although depicted here in separate embodiments, both wired-in and plug/socket connections may be provided in the same connection unit, for example power and optical fiber may be wired in, whilst an umbilical, and external wired communications connections, are provided using a plug and socket arrangement.

Referring to FIGS. 2 and 3 in more detail, these both show the connection unit 2 of embodiments. The unit has fiber inputs/outputs 224, and an Exchange-side connection 22 to the network side 11 of the unit, and distribution-side “copper” wired connections; 220, 221 to the customer side 14 of the unit, with the facility to cross-connect them, or to connect them to external interface unit 5, 6. There are also power input and power delivery connections 223. Power may also be input or delivered through the copper connections 22, 220, 221, 222, 225 if required, for example to provide a reverse power capability to maintain “lifeline” operations in the event of a failure of the power supply feed 223.

For simple telephony connections, a cross-connection 24 between the exchange side connections 22 and customer side connection 220 is all that is required. This may be hard-wired, or controlled remotely from the exchange end or from an interface unit connected by one of the umbilical connections.

In both FIGS. 2 and 3 a connection to an external interface unit 5, 6 is made through an umbilical connection 32, 42 carrying all the required electrical and optical connections. The umbilical can be any length required, depending on the relative locations of the network operator's connection point and the service provider's equipment. For example if the connection point is mounted in a “poletop” location but the interface unit requires regular access, the interface may be provided with a long “tail” connection, for example of about ten meters, to allow it to be located in a ground level equipment cabinet. However, it will be apparent that such a long “tail” is not necessary in all cases. Similarly, the proximity of a suitable power supply point 17 will determine the length of the power supply feeds 223.

In FIG. 2 connection is made by individual connections from the umbilical to individual termination points in the connection block 24 and splice tray 26 within the connection unit 2. In FIG. 3 the connection is made through a plug 40 which terminates the umbilical 42 engaging with a socket 41 in the connection unit, form which wired connections 222, 223, 225 are connected to the connection block 24. The latter arrangement is preferred as it avoids the need to open the housing of the connection unit to make the connections, but the former arrangement may be more appropriate in some circumstances, and in particular if an optical splice is required.

The connection unit 2 may be configured to allow both types of connection 32, 42 to be made.

FIG. 4 shows the interface unit depicted in FIG. 3 in more detail. This unit has a connected cable with connections for plugging into individual terminals within the connection unit. In this example there is an active switch 60 allowing an input copper cable 222 with perhaps fifty wire pairs, linked to sixteen fiber ports so pairs can be linked to ports without needing to send a technician to change jumper wires. The active switch 60 and a control feed carried over the fiber multiplex 224.

FIG. 5 shows the interface unit depicted in FIG. 3 in more detail. In this embodiment, the unit is configured as a DSLAM (digital subscriber line access multiplexer) 50, for multiplexing a plurality of individual subscriber xDSL lines 222 onto an exchange-side high-capacity connection 225. This unit has an umbilical cable 42 which carries the connections 222, 225 and a power supply 223. As previously stated, the umbilical connection may be wired in to the connection unit 2 or it may carry a plug 40 for connection to a socket 41 in the connection unit 2.

FIG. 6 depicts a further interface unit 7, intended to be wired or plugged into the connection unit in a similar manner to the units of FIGS. 5 and 6, but intended for use as a wireless base station. The wireless protocols may be any known system, for example according to the IEEE 802.11 standard, or the cellular GSM system. The unit comprises a radio interface unit 70 for converting signals between the wired system and the wireless system, a transceiver 71, an antenna 72, a beacon system 73 for generating signals broadcasting the presence of the unit, a handover management system 74 for co-ordinating the management of handing over connection to and from other base stations.

The units depicted in FIGS. 4, 5 and 6 are only examples of the applications which may be used with the connection unit, and are not intended to be limitative. Other applications may be provided: for example switching between cross connections may be managed either by taking exchange-side and distribution-side connections to a switch in the interface unit, or providing an interface unit transmitting control signals through the umbilical to an active switch 24 in the connection unit itself.

As the DSLAM 5, FttDP unit 6, wireless base station unit 7 or other interface unit is external to the connection unit 2, it may be replaced, augmented, or reconfigured without interference with the connection unit 2 itself, and its design is not constrained by the interior dimensions of the housing 20. This is particularly useful in circumstances where the interface unit 5, 6, 7 is the responsibility of a service provider separate from the infrastructure operator responsible for maintaining the connections to the reset of the network 11, 14, as each organization only needs access to its own equipment, and can be assured that the other operator has neither the need nor the capability to access it.

1. A connection unit for interconnecting telecommunications lines, the connection unit comprising:
a plurality of termination points for interconnection of telecommunications lines; and
a connection block having provision for a connection between respective termination points of a first line and of a second line and a co-operating interface unit arranged to convert signals from a first communication mode operating on the first line and a second communication mode operating on the second line,
the connection block also being arranged for direct connection between termination points of one or more further pairs of lines in which the mode of operation is common to both lines of a pair.

2. A connection unit according to claim 1, having provision for switching connections in the connection block in response to an external signal.

3. A connection unit according to claim 1, comprising a power connection for an electrical power supply to be delivered to the connection unit.

4. A connection unit according to claim 3, comprising a power connection for an electrical power supply to be delivered by the connection unit.

5. A connection unit according to claim 4, comprising a power management unit for extracting electrical power from a communications line and delivering the power to a destination different from a cross-connection of the communications carried on the communications line.

6. A connection unit according to claim 1, in which the termination points are housed in an enclosure.

7. A connection unit according to claim 6, wherein the enclosure has apertures for passage of communications lines to one or more external interface units.

8. A connection unit according to claim 6, wherein the enclosure has provision for a plug-and-socket connection to be made between the connection unit and one or more umbilical connections to respective interface units.

9. A connection unit according to claim 1, having provision for connection of fiber optic communications lines.

10. A connection unit according to claim 1, having provision for connection of twisted wire pair communications lines.

11. A connection unit according to claim 1, having provision for connection of coaxial cable communications lines.

12. A connection unit according to claim 1, having provision for connection of multicore cable communications lines.

13. A connection unit according to claim 1, having provision for connection of Ethernet communications lines.
